(19) United States
(12) Patent Application Publication
(10) Pub. No.: US 2025/0225042 A1
(43) Pub. Date: Jul. 10, 2025

(54) EFFICIENT LOG FILE TRANSFER AND PROCESSING USING GROUPING OF REGULAR EXPRESSIONS AND SERVICE LEVEL DEPENDENCE

(71) Applicant: KONINKLIJKE PHILIPS N.V., EINDHOVEN (NL)

(72) Inventors: Mauro Barbieri, EINDHOVEN (NL); Johannes Henricus Maria Korst, EINDHOVEN (NL); Erik Agterdenbos, EINDHOVEN (NL); Serverius Petrus Paulus Pronk, VUGHT (NL); Ramon Antoine Wiro Clout, EINDHOVEN (NL)

(21) Appl. No.: 18/700,315

(22) PCT Filed: Oct. 13, 2022
(86) PCT No.: PCT/EP2022/078479

§ 371 Date: Apr. 11, 2024

Related U.S. Application Data
(60) Provisional application No. 63/257,291, filed on Oct. 19, 2021.

(51) Int. Cl. G06F 11/30; G05B 23/02; G06F 11/34

(52) U.S. Cl. CPC G06F 11/3072; G05B 23/0283; G06F 11/3476

(57) ABSTRACT

At least one non-transitory computer readable medium (14, 16, 18) stores log data (20) comprising log data strings generated by a medical imaging device (12); a set of regular expressions (22) for analyzing the log data; and instructions readable and executable by a first computer (14) to: apply regular subexpressions (24) of the set of regular expressions to the log data strings to select a subset of the log data, wherein each regular subexpression is defined by a string that is contained in at least one regular expression of the set of regular expressions; and transfer a portion of the log data consisting of only the subset of the log data to a second computer (16) via a local area network (LAN) and/or the Internet (13).

### FIELD

The following relates generally to the medical device maintenance arts, medical imaging device maintenance arts, medical device log file analysis arts, medical device log file distribution arts, and related arts.

### BACKGROUND

To enable performing failure prediction and reliability analyses on components of medical devices, it is important to have accurate log/event data from the medical device. The data from the medical devices is large in volume and it may be difficult to locate relevant data in these logs. Therefore, specific data patterns that are indicative of imminent component failures or reduced functionality are extracted from the log data. Pattern matching on large volumes of data can be a computationally intensive process.

Medical imaging systems periodically send log files to a central data processing and storage system. The log files can include warning and error messages as well as other data that can be used for preventive maintenance. The log files, consisting of a sequence of log lines, are processed by the pattern matching to extract specific data patterns that are indicative of imminent system failures or reduced functionality.

Multiple medical imaging systems are typically located at a hospital or site. These systems are communicatively connected to a common electronic network, such as a hospital data network. The medical imaging systems that are located at the same site share the communication bandwidth of a communication channel between the site and the central data processing and storage system. An edge device, comprising a computer servicing the hospital, may collect data from the medical imaging devices at that hospital and then forward the collected data to the central data processing and storage system. This conveniently provides uniformity as the edge devices servicing various hospitals can be standardized, for example provided by the medical imaging devices vendor, so that the central data processing and storage system does not need individualized interfaces for connecting with a wide range of different hospital data networks.

The following discloses certain improvements to overcome these problems and others.

### SUMMARY

In one aspect, at least one non-transitory computer readable medium stores log data comprising log data strings generated by a medical imaging device; a set of regular expressions for analyzing the log data; and instructions readable and executable by a first computer to: apply regular subexpressions of the set of regular expressions to the log data strings to select a subset of the log data, wherein each regular subexpression is defined by a string that is contained in at least one regular expression of the set of regular expressions; and transfer a portion of the log data consisting of only the subset of the log data to a second computer via a LAN and/or the Internet.

In another aspect, a distributed computing method comprises using a first computer, applying regular subexpressions of a set of regular subexpressions to strings of a dataset comprising data strings to select a subset of the dataset; and transferring only the subset of the dataset to a second computer via a LAN and/or the Internet. Each regular subexpression of the set of regular subexpressions is defined by a string that is contained in at least one regular expression of a set of regular expressions.

In another aspect, a distributed computing system comprises: a fleet of medical imaging devices generating respective log files; and a hierarchical computer network comprising a plurality of local computers each associated with at least one medical imaging device of the fleet, a plurality of node computers, and a top-level computer. Each local computer is programmed to select a subset of the log data of the at least one medical imaging device associated with that local computer and transfer the subset of the log data to a node computer of the plurality of node computers. The plurality of node computers is programmed to transfer at least a portion of the subset of log data received from each local computer to the top-level computer. The top-level computer is programmed to analyze the log data received from the plurality of node computers.

In another aspect, at least one non-transitory computer readable medium stores log data comprising log data strings generated by a medical imaging device; a set of regular expressions for analyzing the log data; and instructions readable and executable by a first computer to: determine one or more regular subexpressions for filtering the log data wherein each regular subexpression is contained in at least one regular expression of the set of regular expressions; filtering the log data by applying the determined regular subexpressions to the log data strings to select a subset of the log data; and transfer a portion of the log data consisting of only the subset of the log data to a second computer via a LAN and/or the Internet.

One advantage resides in pre-applying common sub-patterns of a set of regular expressions used for analyzing medical imaging device log data to select data subsets, to make the analysis using the regular expressions more efficient, while decreasing computation time.

Another advantage resides in pre-applying common sub-patterns of a set of regular expressions used for analyzing medical imaging device log data to select data subsets for transfer (or prioritized transfer) to a central server, thereby reducing an amount of transferred data (or ensuring rapid transfer of the prioritized data).

Another advantage resides in analyzing an amount of log data relative to a location of the source of the log data, thereby reducing an amount of transferred data.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically illustrates an illustrative system analyzing log data in accordance with the present disclosure.

FIG. 2 shows exemplary flow chart operations of the system of FIG. 1.

FIG. 3 diagrammatically illustrates filtering of log data based on regular subexpressions contained in a set of regular expressions that are to be used in applying predictive modeling to the log data.

FIG. 4 shows another embodiment of the system of FIG. 1.

### DETAILED DESCRIPTION

The central processing system loads the data patterns received from medical imaging devices distributed amongst hospitals into a relational database or other storage for further analysis. As recognized herein, the value of timely transmitting log data from a medical imaging system to the central processing and storage system may depend on various factors, such as whether the data is likely to be predictive of a possible maintenance issue, whether the data relates to a component that is nearing its end-of-lift, whether the medical imaging device is subject to a service level agreement (SLA) between the hospital and the service provider running the central processing system that obligates the latter to assume a large fraction or all of the cost of equipment replacement, and/or so forth.

However, locally available processing and storage capacity at a given hospital or other site may not be sufficient to process and temporarily store the log data of the multiple medical imaging devices deployed at the site. Furthermore, the bandwidth of the local network (e.g., hospital network, edge server communication link, or so forth) may occasionally not be sufficient to transmit the data from the individual imaging systems to the edge devices and a regional network device (if present). Whether the processing, storage and communication resources are sufficient at any given time may depend on the degree of usage of the various medical imaging systems over time. Configuring these resources to provide sufficient capacity and bandwidth to handle worst-case conditions is costly and is typically not done. As a result, important log data for preventive maintenance purposes can get lost, which can potentially increase unplanned downtime.

The following discloses an approach for more efficiently transferring and analyzing, by various predictive models, medical imaging device log data. The predictive models are typically constructed as Boolean combinations of the outputs of regular expressions, and predict events such as X-ray tube failures to enable preventative maintenance to be performed, thereby reducing machine downtime, and enabling the preventative maintenance to be scheduled around imaging device work schedules.

The machine log data is typically stored as strings, with each string of the log file representing an event such as a sensor reading, alert issuance, configuration change, or so forth. Presently, all machine log data are sent to a vendor server (or service provider server; referred to herein more generally as a central server) which then applies a set of regular expressions, the outputs of which serve as inputs to the Boolean combinations implementing the predictive models. This present approach introduces several inefficiencies. First, all the machine log data is transferred even though much of it may be irrelevant for performing the predictive modeling. This wastes communication bandwidth. Second, there is no prioritization of the data transfer-hence, “low-value” data that cannot trigger a predictive model may be sent first, thus delaying transfer of “high-value” data that can (depending on its values) trigger a predictive model. Since the predictive model conventionally cannot be applied until the data arrives at the central server, this introduces delay in applying the predictive models to newly generated log data. Third, each regular expression must be run on every string in the log data, which imposes computational burden on the vendor server. These problems are amplified by the large volume of log data generated by modern medical imaging devices, which can be in the terabit range or larger for a single imaging device output over a short time interval of a few days or so.

This following discloses an approach for filtering the log data before transfer to remove log data that cannot possibly be relevant for the predictive modeling (or, put another way, to select a subset of the data for transfer, or expedited transfer, that has the potential to trigger an alert from the predictive modeling). The approach is premised in part on the recognition that only log data entries (i.e., strings) that satisfy at least one regular expression of the set of regular expressions used in the predictive modeling should be transferred.

In some embodiments disclosed herein, sub-expressions can be extracted from the regular expressions in a way that expedites the filtering. Notably, if a regular expression is a logical conjunction of two or more sub-expressions including (without loss of generality) a sub-expression A, then only a string that satisfies sub-expression A can possibly satisfy the regular expression. Since sub-expressions often recur in multiple regular expressions of the set of regular expressions, this provides an opportunity to produce an initial filtering stage. To do so, a common sub-expression (e.g., sub-expression A in the prior example) that is common to two or more regular expressions is identified. The common sub-expression is applied as a pre-filter, and the two or more regular expressions having that sub-expression in common are applied only to the subset of strings that satisfy the common sub-expression filter.

Even if a regular expression has no subexpressions in common with any other regular expression of the set of regular expressions, efficiency may be gained by applying an easier-to-compute sub-expression of that regular expression at (for example) an edge device (which may be hardware or software) to transmit only strings satisfying that subexpression filter to the vendor (or more generally central) server.

Advantageously, this approach also allows for distribution of the evaluation of the regular expressions of the set of regular expressions over a hierarchy of computing resources. For example, the common sub-expression filters can be applied at an edge device implemented at the hospital network, and only log data strings satisfying at least one of the common sub-expressions is transferred to the vendor server, where the full regular expressions are applied to that received sub-set of the log data.

The following also discloses approaches for prioritizing transfer of log data to the vendor server. Various bases for prioritizing log data are disclosed, including: service level agreement (where log data of machines having service agreements imposing higher cost on the vendor are prioritized); failure prediction results (where, for example, log data of an X-ray machine whose X-ray tube is nearing end-of-life as predicted by the failure prediction modeling are prioritized); customer designation of critical imaging devices or clinical departments (log data of customer-designated critical devices or devices in clinical departments are prioritized); patient schedule information (log data of imaging devices with heavy patient workloads are prioritized); battery level (in portable devices, log data of a device whose battery level is low is prioritized); and/or so forth. As previously mentioned, pre-filtering using sub-expressions can also be used to select the priority subset of data for transfer (or expedited transfer).

The disclosed system in some embodiments further monitors efficiency metrics such as storage capacity at the edge devices and at any regional servers, and communication bandwidth, along with the prioritizations to prioritize data transfers from the edge devices to regional servers and from regional servers to the main vendor server. The prioritization is stored in priority configuration tables of the edge devices and any regional servers, and both the efficiency metrics and contents of the priority configuration tables may change dynamically as, for example, failure prediction models indicate new components nearing end-of-life, battery meters indicate low power, patient workloads change, and/or so forth.

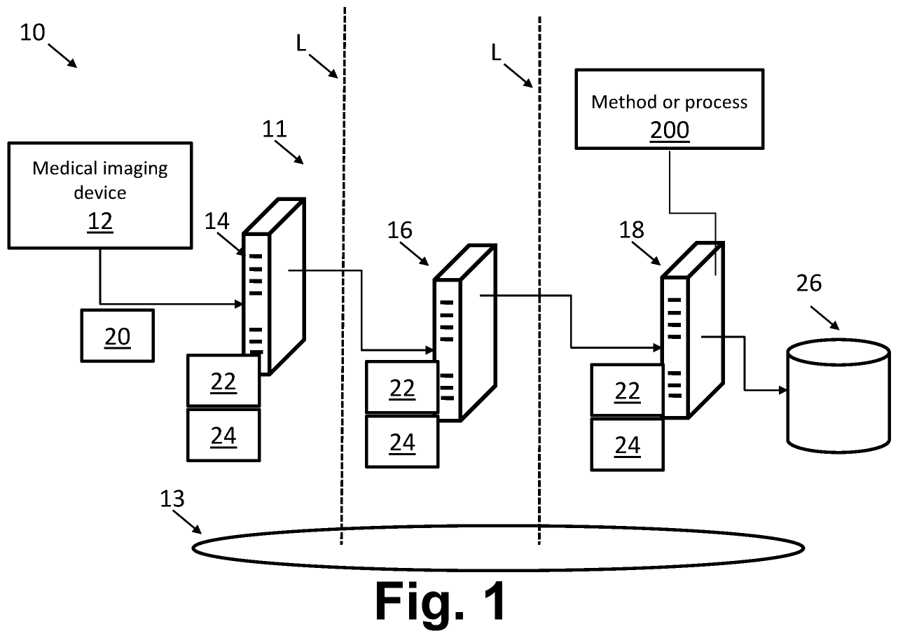

With reference to FIG. 1, an illustrative servicing support system 10 for supporting a service engineer in servicing a device 12 (e.g., a medical imaging device as shown in FIG. 1—also referred to as a medical device, an imaging device, imaging scanner, and variants thereof) is diagrammatically shown. By way of some non-limiting illustrative examples, the medical imaging device under service may be a magnetic resonance imaging (MRI) scanner, a computed tomography (CT) scanner, a positron emission tomography (PET) scanner, a gamma camera for performing single photon emission computed tomography (SPECT), an interventional radiology (IR) device, or so forth. (More generally, the disclosed approach can be applied in conjunction with any type of computerized device or machine that automatically generates log data that are analyzed by predictive models to predict component failures, e.g., the approach could be applied to a commercial airliner, radiation therapy device, a cardo ship, an industrial robot, or so forth). In addition, although only a single device 12 is shown in FIG. 1, the support system 10 can analyze log data from a fleet of devices 12 (i.e., more than one device).

As shown in FIG. 1, the servicing support system 100 includes, or is accessible by, a hierarchical network 11 comprising one or more distributed computers electronically connected to each other via an electronic network 13 (e.g., a wired connection, a local area network (LAN), the Internet, wireless Wi-Fi or 4G/5G interface or the like for connection to the Internet and/or an intranet, and so forth).

The hierarchical network 11 includes one or more local computers 14 (i.e., first computers or “edge devices”) configured to analyze log data from the device 12. A number of first computer 14 corresponds to the number of devices 12 in the fleet. For example, the first computer(s) 14 can be disposed adjacent to, or in a same building as, the corresponding device(s) 12. A single first computer 14 is shown in FIG. 1, and can comprise a server computer (e.g., single server computer, or a server cluster, or a cloud computing resource comprising ad hoc-interconnected server computers, or so forth).

The hierarchical network 11 also includes one or more node computers 16 (i.e., second computers or “regional network devices”). Each local computer 14 is programmed to select a subset of the log data of the device(s) 12 associated with a corresponding local computer 14 and transfer the subset of the log data to a corresponding node computer 16. A single second computer 16 is shown in FIG. 1, and can comprise a server computer (e.g., single server computer, or a server cluster, or a cloud computing resource comprising ad hoc-interconnected server computers, or so forth).

The hierarchical network 13 further includes a top-level computer 18 (i.e., a third computer or a central server). The node computer(s) 16 is programmed to transfer at least a portion of the subset of log data received from each local computer 14 to the top-level computer 18. The top-level computer 18 is then programmed to analyze the log data received from the plurality of node computers 16. The third computer 18 is shown in FIG. 1, and can comprise a server computer (e.g., single server computer, or a server cluster, or a cloud computing resource comprising ad hoc-interconnected server computers, or so forth).

The device(s) 12 is configured to generate a dataset of log data 20 for analysis by the server computers 14, 16, 18. The log data 20 can comprise (or at least be capable of being represented as) log data strings generated by the device 12. The log data 20 for a particular device 20 can be transferred to the corresponding first computer 14. In addition, as shown in FIG. 1, each of the computers 14, 16, 18 can be located in geographically diverse locations (as indicated by the dashed lines L in FIG. 1).

Each of the first, second, and third computers 14, 16, 18 also comprises a non-transitory computer readable medium configured to store a set S of regular expressions 22 for analyzing the log data 20 from the device 12. The set S of regular expressions 22 define one or more failure prediction models for predicting time to failure for one or more components of the device 12 (for example, an X-ray tube of a medical imaging device 12). Each regular expression 22 in the set S of regular expressions 22 can include a set S′ one or more regular subexpressions 24 defined by a string that is contained in at least one regular expression 22 of the set S of regular expressions 22. For example, each regular subexpression 24 of the set S′ of regular subexpressions 24 is defined by a string that is contained in at least two regular expressions 22 of the set S of regular expressions 22.

Each of the first, second, and third computers 14, 16, 18 store instructions executable by electronic processors of the computers 14, 16, 18 to perform a distributed computing method 200 analyzing the log data 20 from the device(s) 12.

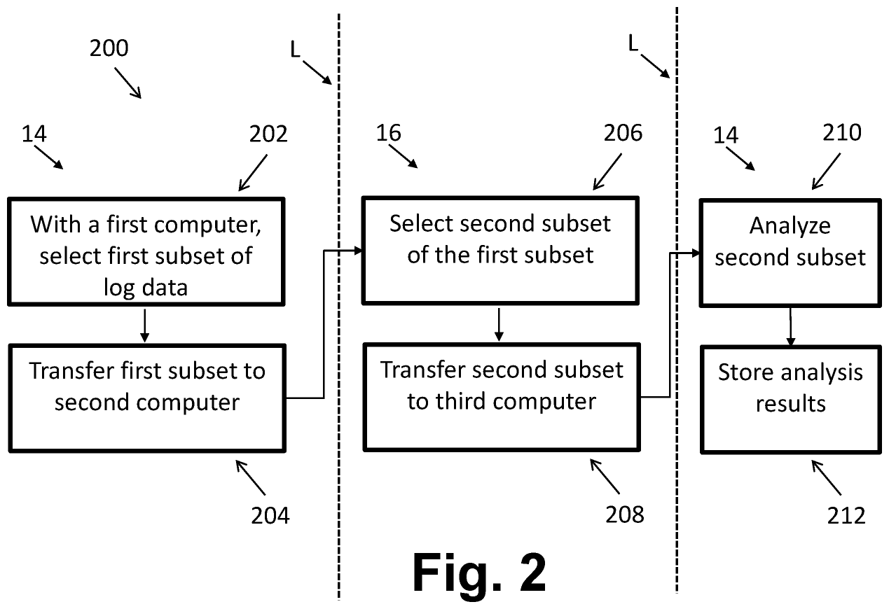

With continuing reference to FIG. 1 and further reference to FIG. 2, an illustrative embodiment of the method 200 is diagrammatically shown as a flowchart. In some examples, the method 200 may be performed at least in part by cloud processing.

To begin the method 200, at an operation 202, the first computer 14 is programmed to apply regular subexpressions 24 from the set S′ of regular expressions 22 to the log data strings 20 to select a subset (i.e., a first subset) of the log data 20. Since the sub-expressions 24 often recur in multiple regular expressions 22 of the set S of regular expressions 22, this provides an opportunity to produce an initial filtering stage.

To determine which subexpression(s) should be applied, a common sub-expression 24 that is common to two or more regular expressions 22 is identified. The subexpression(s) 24 can be a fixed (i.e., set) subexpression, a dynamic (i.e., can be updated) subexpression, or a combination thereof. In one approach, the regular subexpressions 24 can be selected for use in the operation 202 based on the number of occurrences of the subexpressions in the S′ of regular expressions 22. In general, a subexpression that occurs in many of the regular expressions 22 is likely to be a useful subexpression for selecting the subset of the log data 20, and can be considered a candidate subexpressions. As a limiting case, a subexpression that occurs in every one of the regular expressions 22 can be a candidate subexpression, since any log data string that does not match that subexpression cannot match any of the regular expressions 22. Another criterion for selecting the subexpressions 24 may be the complexity of the subexpression evaluation. A candidate subexpression 24 whose evaluation against (i.e. matching to) a log data string is fast is well suited for use in the operation 202. In an empirical approach, the regular subexpressions 24 can be selected for use in the operation 202 based on empirical testing against a test set of typical log data. For example, a useful set of subexpressions is one that filters out a substantial fraction of the log data strings of the test log data, thus providing for selecting a smaller subset of the log data 20 and increasing efficiency of the subsequent transfer of the subset of the log data 20. The empirical testing can also incorporate speed of evaluation of the set of subexpressions 24 against the test set of typical log data as a criterion in selecting an optimal set of subexpressions 24. In other examples, of a combined set/dynamic subexpression 24, a preliminary set of candidate subexpression(s) 24 can be set to a default prioritization, that can then be altered by one or more of (i) an error code; (ii) a user/technician input or comments regarding the error or nature of the error; or (iii) a RSE diagnosing the problem. In another example, the subexpression(s) 24 may also be set by contract (e.g., frequency in which to pull certain data, particularly for preventive maintenance). The selected subset of the subexpression(s) 24 may also be adjusted during the course of transfer (e.g., if a new or different pattern takes precedence) of the log data 20.

In another embodiment, the local computer 14 is programmed to select the subset of the log data 20 by also applying the regular expressions 22 to the log data 20. The selection of the subset of the log data 20 can be based on one or more criteria, such as a service level agreement associated with the device 12, a downtime of the device 12, an estimated time to failure of a component of the device 12, and so forth.

Once the first subset of the log data 20 is selected, at an operation 204, the selected subset is transferred to the second computer 16 via the electronic network 13. In some embodiments, after the transfer of the subset, the remainder of the log data 20 can be transferred to the second computer 16.

In another example, the amount of log data 20 (and thus the selection of the subexpression(s) 24) can further be defined by the usage of the medical device 12. For example, the subexpression(s) 24 can be narrowly tailored to select a small subset of the log data 20 if the medical device 12 is in use or will be in a short time frame, or can be broken into parts or timed based on the schedule for the medical device 12. It can also be used to prioritize data transmission windows based on schedule or usage (e.g., two subexpressions 24 have the same priority, but one can transmit twice as quickly given either computed or estimate data amount), resulting in two transmission windows, one half the size as the next, and thus match the priority/size to the transmission window schedule.

At an operation 206, the second computer 16 is programmed to analyze the transferred portion (i.e., the first subset) of the log data 20 using the set of regular expressions 22. To do so, in some embodiments, the second computer 16 is configured to apply further regular subexpressions 24 of a second set S″ of regular subexpressions 24 to the log data strings 20 to select a subset (i.e., a second subset) of the subset of the log data 20. In other words, the second subset is a subset of the first subset. Each further regular subexpression 24 is defined by a string that is contained in at least one regular expression 22 of the set S of regular expressions 22.

Once the second subset is selected, at an operation 208, the second subset is transferred to the third computer 18 via the electronic network 13.

At an operation 210, the third computer 18 is programmed to analyze the second subset of the log data 20 using the set of regular expressions 22. At an operation 212, the results of this analysis are stored at the third computer 18 in a database 26.

In the following, a suitable framework for defining sub-expressions of a set of regular expressions for use in the data filtering is described. For example, regular subexpressions 24 of the set of regular expressions 22 may be applied to the log data strings to select a subset of the log data. Each regular subexpression is defined by a string that is contained in at least one regular expression of the set of regular expressions 22. A portion of the log data is then transferred, consisting of only the subset of the log data to a second computer via a LAN and/or the Internet.

To provide a more detailed description of this process of filtering the data by applying sub-expressions, the source data (log data) is assumed to be an ordered set S={s₁, s₂, . . . , s_{N}} of strings. A set R={r₁, r₂, . . . , rₙ} of patterns is defined as regular expressions rᵢ on S. For example, the set of regular expressions R may be the set of regular expressions 22 of FIG. 1.

In general, one regular expression r is said to be included in another regular expression r′ if the following holds for any string s∈S: If r matches s then r′ matches s.

A regular expression r is said to contain a string x if the following holds for any string s∈S: If r matches s then x is a substring of s. To apply this to the example of FIG. 1, each regular subexpression 24 is defined by a string x that is contained in at least one regular expression rᵢ of the set of regular expressions 22.

To ensure the filtering provides improved efficiency, the string x may be selected such that string x is contained in at least two regular expressions rᵢ₁ and rᵢ₂ of the set of regular expressions 22.

Also note that by definition any regular expression contains the empty string. In some embodiments, the regular expressions 22 are limited to expressions without negative clauses (negative look-aheads or negative look-behinds).

For a regular expression r, the set S(r) is defined as the subset of strings in S that match pattern r. In the instant case, the goal is that, given the log data comprising a set of strings, filter to determine a subset of strings {S(r₁), S(r₂), . . . , S(rₙ)} that may match the set of regular expressions R 22.

The following can be stated.

First, if two expressions rᵢ and rⱼ contain the same substring x, then x can be used as an additional pattern rᵢⱼ. That is, rᵢⱼ can serve as one of the regular subexpressions 24. Pattern matching for rᵢⱼ can be performed before rᵢ and rⱼ of the set of regular expressions 22 are performed on S individually, so that the matching set S(rᵢⱼ) can be used for the creation of S(rᵢ) and S(rⱼ), as S(rᵢ)⊆S(rᵢⱼ) and S(rⱼ)⊆S(rᵢⱼ).

Second, if expression r is included in r′, then r′ can be performed before r so that the matching set S(r′) can be used for the creation of S(r) as S(r)⊆S(r′).

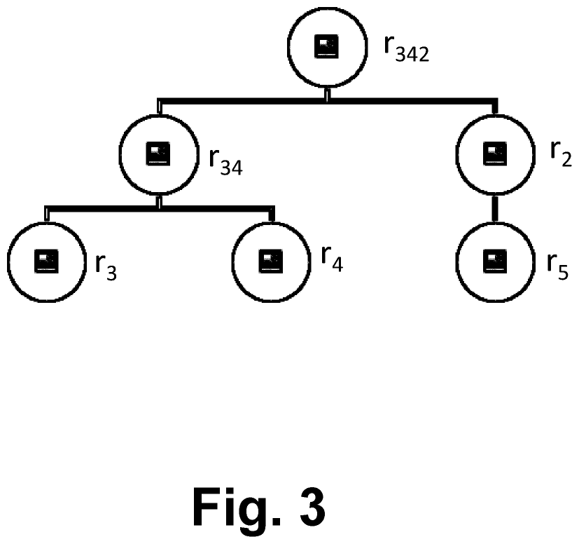

With reference to FIG. 3, by way of a nonlimiting illustrative example this paradigm of expressions contained in other expressions can be represented as a pattern tree shown in FIG. 3. In this example expression r₃ and expression r₄ contain the same substring x represented by pattern r₃₄ representing x. Expression r₂ is a substring of expression r₅. As any two regular expressions contain the empty string, it is always possible to create such a tree.

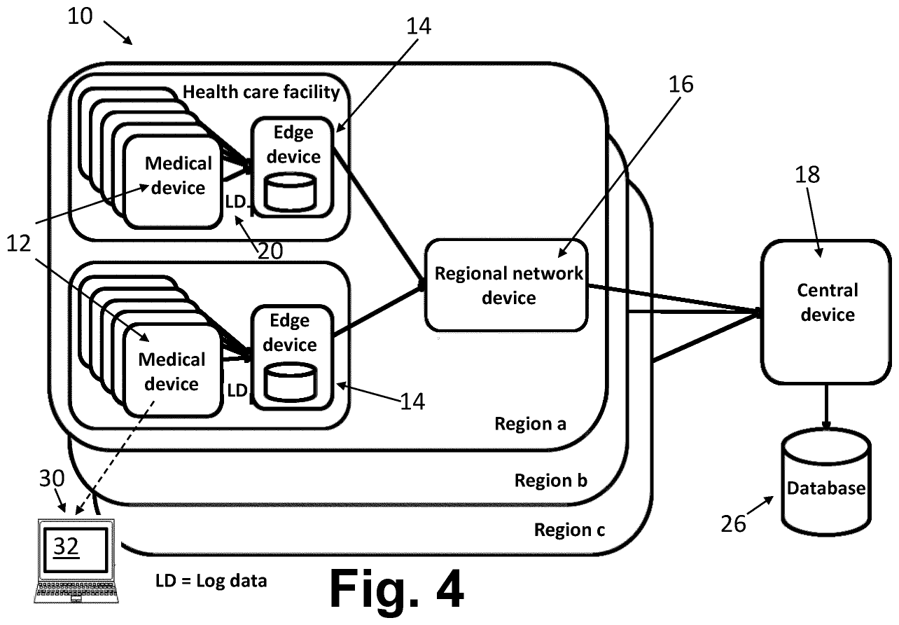

In addition to the constructed pattern tree of FIG. 3, there is a geographical end-to-end chain of computing devices between the medical device 12 and eventual storage in the database 26, as diagrammatically shown in FIG. 4. Patterns from the pattern tree of FIG. 3 can be mapped at tree-depth [0 . . . k) to the first computation nodes in the chain, patterns at tree-depth [k . . . m) to the second, and so on, to provide filtering by regular subexpressions 24 to identify subsets of data to transfer from one computer to the next in the geographical end-to-end chain of computing devices.

To implement such a system, in one approach the set of regular subexpressions 24 are generated manually by examination of the regular expressions 22 to identify subexpressions contained in at least one of the regular expressions 22. To increase efficiency, it may be beneficial to select regular subexpressions contained in at least two of the regular expressions of the set of regular expressions 22. In general, the selection of the set of regular subexpressions 24 should be chosen so that every possible string that might satisfy any regular expression of the set of regular expressions 22 is covered. This is straightforwardly achieved by ensuring that, for each regular expression of the set of regular expressions 22, the set of regular subexpressions 24 contains at least one regular subexpression that is contained in that regular expression.

As further shown in FIG. 4, a customer electronic processing device 30 (e.g., a workstation computer, a laptop, a smart tablet, and so forth) can be disposed in a same area as the medical device 12, and be operable by a customer of the medical device 12. A customer user interface (UI) 32 can be displayed on the customer electronic processing device 30. The customer can then input data to the UI 32, such as inputs for determining the expression(s) 22 or subexpression(s) for the operation 202. The UI 32 can also be used to collect user information regarding the nature of the issue, or it can use usage data and/or a schedule of the medical device 12 to define the expression(s) 22 or subexpression(s) 24 and the time for data transfer. The UI 32 can also be used to make suggestions, such as, for example, moving a usage start time back by twenty minutes to gain “X” percentage of probable issue resolution as long as the issue does not directly affect the immediate safe and effective use of the medical device 12.

In the following, some nonlimiting illustrative examples are provided to illustrate further aspects which are to be understood as being amenable to being variously combined, with certain aspects optionally being omitted in certain specific implementations.

### EXAMPLES

The system 10 is configured to adapt the processing, storage and communication resources in a local sub-network that are used to transmit and process log data from a medical imaging device 12 to the central processing and storage system (i.e., the third computer 18) to the agreed service level. The different service levels for the various devices 12 are assumed to be expressed by, for example, a natural number, where a higher number indicates a higher service level. Now, in case of restricted processing, storage or communication resources in the sub-network, the log data 20 can be filtered based on the related service level, such that log data 20 with a high service level is given preference at the cost of log data 20 with a lower service level.

In some embodiments, the mapping of patterns over the locations of the devices 12 (and hence offloading of computations over the network) may be performed dynamically, considering the current load of a processing node and the processing and storage capacity of the processing node. Hence, it could be the case that at some location the edge device 14 has higher processing and storage capacity than at another location (i.e., a hospital). As such, the computations could be distributed dynamically such that the load is distributed over the whole processing chain, so that the average (or worst-case) throughput is minimized.

In some embodiments, a service level for the device 12 is primarily defined by a service level agreement. This agreement describes the maximum amount of downtime in measurement window, for instance the maximum number of unplanned downtime hours in a window of one month. A higher service level for a particular device 12 can be assigned because a customer has a better service level agreement for a particular device 12 that are business critical, such as contracts, type of equipment, type of procedures scheduled, location of the equipment (i.e., equipment located in or used by an emergency room can be assigned a higher service level), or patient schedule. Log files 20 from devices 12 with a higher service level than other devices 12 should be stored, transmitted, and processed with higher priority, could trigger the transmission of more detailed log files 20, or be transferred more frequently.

A service level can also be dynamically based on the downtime of the device 12 in a particular time window. When the downtime of a particular device 12 approaches the limit that is defined in the service level agreement, the service level of that device 12 will be automatically adapted to decrease the likelihood that the downtime exceeds the agreed level. Service level agreements can also be related to a group of similar devices 12, such as patient monitors. The agreement can specify that a certain minimum percentage of devices 12 is operational at any time. When too many devices 12 fail simultaneously, the service level for the remaining devices 12 are automatically adapted to decrease the likelihood that too many devices 12 become non-operational.

In some embodiments, specific log data 20 can be given a higher or lower service level depending on additional factors, such as, for example, the age or the accumulated usage of a specific subsystem or part of the device 12. For example, suppose that the device 12 is a medical imaging system and has an X-ray tube as part, and that a service is agreed between the hospital and the service provider to predict when the X-ray tube is expected to fail, such that it can be replaced preventively, before it fails. In that case, the value of timely transmission of the relevant log data related to the aging of the X-ray tube is basically determined by service level agreement related to the specific service. However, one can also consider the age or the accumulated usage of the X-ray tube. If the tube is relatively new and it has not been used much, then it is very unlikely that filament of the X-ray tube (that is assumed to be the dominant failure mode) is going to fail soon. In that case, most of the related log data may be simply filtered out in case of lack of processing, storage, or communication resources. In that case, aggregate data on the accumulated usage may be sufficient to be transmitted.

FIG. 4 shows another example of the system 10. Each device 12 transmits the log files 20 to an edge device 14 (i.e., the first computer) for temporal storage. The edge device 14 collects the data from the devices 12 and sends them to the service provider (i.e., to the second computer 16).

In some embodiments, the edge devices 14 keep track of the service levels for all devices 12. The edge device 14 always first transmits log files 20 from the devices 12 with a highest service level. Consequently, log files 20 from lower priority devices 12 are queued when the network connection 14 to the regional network device 16 provides insufficient capacity. When the regional network device 16 becomes full, the oldest files from devices 12 with a lower service level are deleted until sufficient space is available to store incoming log files 20 from the devices 12.

In another embodiment, the edge device 14 keeps track of the availability of the device(s) 12. The unplanned downtime is measured as a number of hours d in a period p. The service level agreement specifies a maximum downtime hours L. A problem downtime threshold t is defined with t<L. When d>=t, the edge device 14 increases the service level with T steps. L, t, and T are set by the service provider. Depending on these settings, a device 12 that has downtime above the threshold might become the device 12 with the highest service level or not.

In another embodiment, the edge device 14 keeps track of the age or usage hours u for critical parts that fail more often during the beginning or end of their lifetime. A minimum and/or maximum usage hour threshold u_min or u_max is defined in the edge device 14 for these parts. When u<u_min or u>u_max, the service level for this device 12 is increased with U steps. Depending on these settings, a device 12 that contains a part outside the safe usage period might become the device 12 with the highest service level.

A non-transitory storage medium includes any medium for storing or transmitting information in a form readable by a machine (e.g., a computer). For instance, a machine-readable medium includes read only memory (“ROM”), solid state drive (SSD), flash memory, or other electronic storage medium; a hard disk drive, RAID array, or other magnetic disk storage media; an optical disk or other optical storage media; or so forth.

The methods illustrated throughout the specification, may be implemented as instructions stored on a non-transitory storage medium and read and executed by a computer or other electronic processor.

The disclosure has been described with reference to the preferred embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. At least one non-transitory computer readable medium storing:
log data comprising log data strings generated by a medical imaging device;
a set of regular expressions for analyzing the log data; and
instructions readable and executable by a first computer to:
apply regular subexpressions of the set of regular expressions to the log data strings to select a subset of the log data, wherein each regular subexpression is defined by a string that is contained in at least one regular expression of the set of regular expressions; and
transfer a portion of the log data consisting of only the subset of the log data to a second computer via a local area network (LAN) and/or the Internet.

2. The at least one non-transitory computer readable medium of claim 1, wherein each regular subexpression of the set of regular expressions is defined by a string that is contained in at least two regular expressions of the set of regular expressions.

3. The non-transitory computer readable medium of claim 1, wherein the set of regular expressions define one or more failure prediction models for predicting time to failure for one or more components of the medical imaging device.

4. The at least one non-transitory computer readable medium of claim 1, further storing instructions readable and executable by the second computer to analyze the transferred portion of the log data using the set of regular expressions.

5. The at least one non-transitory computer readable medium of claim 1, further storing:
instructions readable and executable by the second computer to:
apply further regular subexpressions of a second set of regular subexpressions to the log data strings to select a subset of the subset of the log data, wherein each further regular subexpression is defined by a string that is contained in at least one regular expression of the set of regular expressions; and
transfer a portion of the subset of the log data consisting of only of the subset of the subset of the log data to a third computer via a local area network (LAN) and/or the Internet; and
instructions readable and executable by the third computer to analyze the transferred portion of the subset of the log data using the set of regular expressions.

6. The non-transitory computer readable medium of claim 1, wherein the instructions are readable and executable by the first computer to:
after the transfer of the portion of the log data consisting of only the subset of the log data to the second computer is complete, transfer a remainder of the log data not including the subset of the log data to the second computer via the LAN and/or the Internet.

7. The non-transitory computer readable medium of claim 1, wherein the instructions are readable and executable by the first computer to:
determine the regular subexpressions to be applied to the log data strings to select the subset of the log data.

8. The non-transitory computer readable medium of claim 7, wherein the determination of the regular subexpressions to be applied to the log data strings to select a subset of the log data includes:
determining numbers of occurrences of candidate regular subexpressions in the set of regular expressions, the determination of the regular subexpressions being based at least in part on the numbers of occurrences.

9. The non-transitory computer readable medium of claim 7, wherein the determination of the regular subexpressions to be applied to the log data strings to select a subset of the log data includes:
determining complexities of candidate regular subexpressions in the set of regular expressions relative to the log data strings, the determination of the regular subexpressions being based at least in part on the complexities.

10. The non-transitory computer readable medium of claim 7, wherein the determination of the regular subexpressions to be applied to the log data strings to select a subset of the log data includes:
determining the regular subexpressions in accordance with a default prioritization level.

11. The non-transitory computer readable medium of claim 10, wherein the instructions further include:
adjusting the default prioritization level based on one or more (i) an error code; (ii) an input or comments regarding the error or nature of the error; or (iii) the SE diagnosing the problem.

12. The non-transitory computer readable medium of claim 7, wherein the determination of the regular subexpressions to be applied to the log data strings to select a subset of the log data includes:
determining a usage of the medical device, the determination of the regular subexpressions being based at least in part on the usage of the medical device.

13. The non-transitory computer readable medium of claim 7, wherein the determination of the regular subexpressions to be applied to the log data strings to select a subset of the log data includes:
determining a time window for transmitting the log data of the medical device, the determination of the regular subexpressions being based at least in part on the time window.

14. A distributed computing method, comprising:
using a first computer, applying regular subexpressions of a set of regular subexpressions to strings of a dataset comprising data strings to select a subset of the dataset; and
transferring only the subset of the dataset to a second computer via a local area network (LAN) and/or the Internet;
wherein each regular subexpression of the set of regular subexpressions is defined by a string that is contained in at least one regular expression of a set of regular expressions.

15. The distributed computing method of claim 14, wherein each regular subexpression of the set of regular subexpressions is defined by a string that is contained in at least two regular expressions of the set of regular expressions.

16. The distributed computing method of claim 14, further comprising:
using the second computer, analyzing the transferred subset of the dataset using the set of regular expressions.

17. The distributed computing method of claim 14, further comprising:
using the second computer, applying further regular subexpressions of a second set of regular subexpressions to the strings of the subset of the dataset to select a subset of the subset of the dataset, wherein each further regular subexpression is defined by a string that is contained in at least one regular expression of the set of regular expressions;
transfer the subset of the subset of the dataset from the second computer to a third computer via a local area network (LAN) and/or the Internet; and
using the third computer, analyzing the transferred subset of the subset of the dataset using the set of regular expressions.

18. The distributed computing method of claim 14, further comprising:
after the transfer of only the subset of the dataset to a second computer is complete, transferring a remainder of the dataset not including the subset of the dataset to the second computer via the LAN and/or the Internet.

19. The distributed computing method of claim 14, wherein the dataset comprises a log file of a computerized machine comprising log data strings generated by the computerized machine.

20. The distributed computing method of claim 19, wherein the set of regular expressions define one or more failure prediction models for predicting time to failure for one or more components of the computerized machine.

21. A distributed computing system, comprising:
a fleet of medical imaging devices generating respective log files; and
a hierarchical computer network comprising a plurality of local computers each associated with at least one medical imaging device of the fleet, a plurality of node computers, and a top-level computer, wherein:
each local computer is programmed to select a subset of the log data of the at least one medical imaging device associated with that local computer and transfer the subset of the log data to a node computer of the plurality of node computers,
the plurality of node computers is programmed to transfer at least a portion of the subset of log data received from each local computer to the top-level computer, and
the top-level computer is programmed to analyze the log data received from the plurality of node computers.

22. The distributed computing system of claim 21, wherein each local computer is programmed to select the subset of the log data by operations including applying regular expressions to the log data.

23. The distributed computing system of claim 21, wherein each local computer is programmed to select the subset of the log data based at least on a service level agreement associated with at least one medical imaging device.

24. The distributed computing system of claim 21, wherein each local computer is programmed to select the subset of the log data based at least on downtime of at least one medical imaging device over a predefined time window.

25. The distributed computing system of claim 21, wherein each local computer is programmed to select the subset of the log data based at least on an estimated time to failure of a component of at least one medical imaging device.

26. At least one non-transitory computer readable medium storing:
log data comprising log data strings generated by a medical imaging device;
a set of regular expressions for analyzing the log data; and
instructions readable and executable by a first computer to:
determine one or more regular subexpressions for filtering the log data wherein each regular subexpression is contained in at least one regular expression of the set of regular expressions;
filtering the log data by applying the determined regular subexpressions to the log data strings to select a subset of the log data; and
transfer a portion of the log data consisting of only the subset of the log data to a second computer via a local area network (LAN) and/or the Internet.
